(19) United States
(12) Patent Application Publication
(10) Pub. No.: US 2019/0018978 A1
(43) Pub. Date: Jan. 17, 2019

(54) SYSTEM AND METHOD FOR OBTAINING PERMISSIONS TO EXCHANGE PRIVACY RELATED INFORMATION ACROSS JURISDICTIONAL BOUNDARIES

(71) Applicant: Bilal Soylu, Sanford, NC (US)

(72) Inventor: Bilal Soylu, Sanford, NC (US)

(21) Appl. No.: 15/978,809

(22) Filed: May 14, 2018

Related U.S. Application Data
(60) Provisional application No. 62/532,469, filed on Jul. 14, 2017.

(51) Int. Cl. G06F 21/62; G06F 21/60

(52) U.S. Cl. CPC G06F 21/6245; G06F 21/604

(57) ABSTRACT

A system and method for obtaining permissions to exchange privacy related information across jurisdictional boundaries. The system allows a data-subject to see who is using their data and how many times it is exchanged. The system may also assist data-subjects with blocking current use of their data and automatically preventing their data-set from being exchanged. Similarly, the system may allow data-subjects to offer their data for sale to data-users. This can be in multiple forms including the ability to offer their data to businesses as they stroll by.

### CROSS-REFERENCE TO RELATED APPLICATION

This application claims the benefit of priority of U.S. provisional application No. 62/532,469, filed Jul. 14, 2017, the contents of which are herein incorporated by reference.

### BACKGROUND OF THE INVENTION

The present invention relates to systems and methods for exchanging privacy information, and more particularly to exchanging privacy information across jurisdictional boundaries having varied privacy data protection regimes.

In a digital world, the need to exchange personal user data has increased while at the same time it is coming under greater scrutiny. Laws governing the exchange of such personal data are active in large jurisdictions, such as the European Union (EU) and are under consideration in other places. However, the need for users to communicate this data and for businesses to use it without running afoul of the laws in various jurisdictions still exists. Users (data-subjects) wish to control the exchange of their data while at the same time desiring to obtain services from businesses. Businesses wish to communicate this data with their geographically distributed partners and subsidiaries to provide the services or suggest additional services to consumers (data-subjects). Businesses wish to remain compliant, while at the same time wanting to find a cost competitive way to operate. Currently, handling communication with each consumer is not effective for this purpose.

Current systems mechanisms for data transfer solely rely on company's internal controls and are working on the honor system. Manual self-certification via a compliance office and or compliance officer is the standard. More sophisticated system exist in the digital media realm but generally focus on blocking playback of media by country. Existing transfer systems generally do not analyze a massive collection of data records or attempt to ascertain that each individual record has sufficient clearance to be exported (moved across legal boundaries). In addition, current systems lack a mechanism to contact and start automatic negotiations with data-subjects who in turn can set their export policies independently.

As can be seen, there is a need for an improved system and methods that allow data-subjects to see who is using their data and how many times it is exchanged. There is also a need to assist data-subjects with blocking the current use of their data and for automatically preventing their data-set from being exchanged. Similarly, if data-subjects can offer their data for sale to data-users.

As can be seen, there is a need for an improved process and method that makes the impracticalities of privacy related communication from one to many for purpose of obtaining sharing consent possible.

### SUMMARY OF THE INVENTION

In one aspect of the present invention, a computerized method for controlling the exchange of a file, containing one or more elements of privacy information (PI), between a data exporter and a data importer, is disclosed. The method includes initiating a transfer of a file within a computer network between the data-exporter and the data importer, the file containing PI data of a data-subject. The network then determines whether the transfer will transit a PI jurisdictional boundary between the data exporter and the data importer. When the PI jurisdictional boundary does not exist, the file is transferred to the data importer.

In some embodiments, when the PI jurisdictional boundary exists, one or more governing PI data policies between a first jurisdiction of the data exporter and a second jurisdiction of the data importer are analyzed. When the one or more governing PI data policies indicates a destination exception for the second jurisdiction, the file is transferred to the data importer.

In other embodiments, when the PI jurisdictional boundary exists, one or more governing PI data policies between a first jurisdiction of the data exporter and a second jurisdiction of the data importer are analyzed to determine whether the one or more PI data policies specifies a file level exception for the PI data. When a file level exception exists, the file is transferred to the data importer. When a file level exception does not exist, a failure report is generated.

Other embodiments include the data exporter registering a transfer justification with the network, the transfer justification specifies a combination of a data type and a destination. The method then determines whether the file satisfies the transfer justification. When the file satisfies the transfer justification the file is transferred to the data importer. When the file does not satisfy the transfer justification, an authorizing party of the data exporter is prompted for a specific authorization to transmit the file across the jurisdictional boundary. When the authorizing party approves the specific authorization, authorizing the transfer of the file across the jurisdictional boundary, the file is transmitted to the data importer. When the specific authorization is not received, a failure report is generated.

In other embodiments of the computerized method, when the transfer justification is not satisfied, a determination for each of a plurality of records contained in the file, is made to ascertain whether a record authorization exists for each of the plurality of records. When the record authorization exists for each of the plurality of records in the file, the file is transferred to the data importer. When the record authorization does not exist for each of the plurality of records in the file, a failure report is generated.

In yet other embodiments of the computerized method, when the PI jurisdictional boundary exists, one or more governing PI data policies between a first jurisdiction of the data exporter and a second jurisdiction of the data importer are analyzed. The file is deconstructed to perform a record level privacy export assessment for each a plurality of records contained in the file against the one or more governing PI data policies. An authorized record, satisfying the one or more governing PI data policies to an authorized record file.

In other embodiments a determination is made whether the data subject of an individual record is associated with the computer network, and whether the associated data subject has provided a prior PI data transmission authorization with the network. If the associated data subject has provided a prior authorization for transferring of PI data of the data subject, an associated record of the associated data subject is added to the authorized record file.

In other embodiments, when the associated data subject has not provided a prior authorization, the network solicits an authorization from the associated data subject. When the associated data subject approves the authorization, the associated record is added to the authorized record file. In some embodiments, the solicitation may include offering an incentive to the associated data subject.

In yet other embodiments, the computerized method includes inserting a tracking data into the file, the tracking data enabling the data subject to determine a misuse of the PI data.

These and other features, aspects and advantages of the present invention will become better understood with reference to the following drawings, description and claims.

### BRIEF DESCRIPTION OF THE DRAWINGS

FIG. 1 is a flow chart of a process according to aspects of the invention.

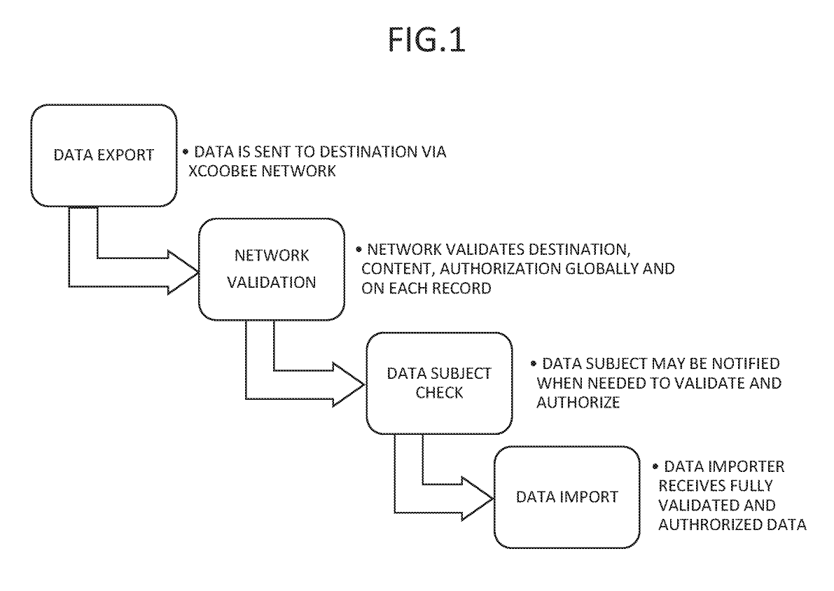

FIG. 2 is a representative flow chart of a system and method according to aspects of the invention.

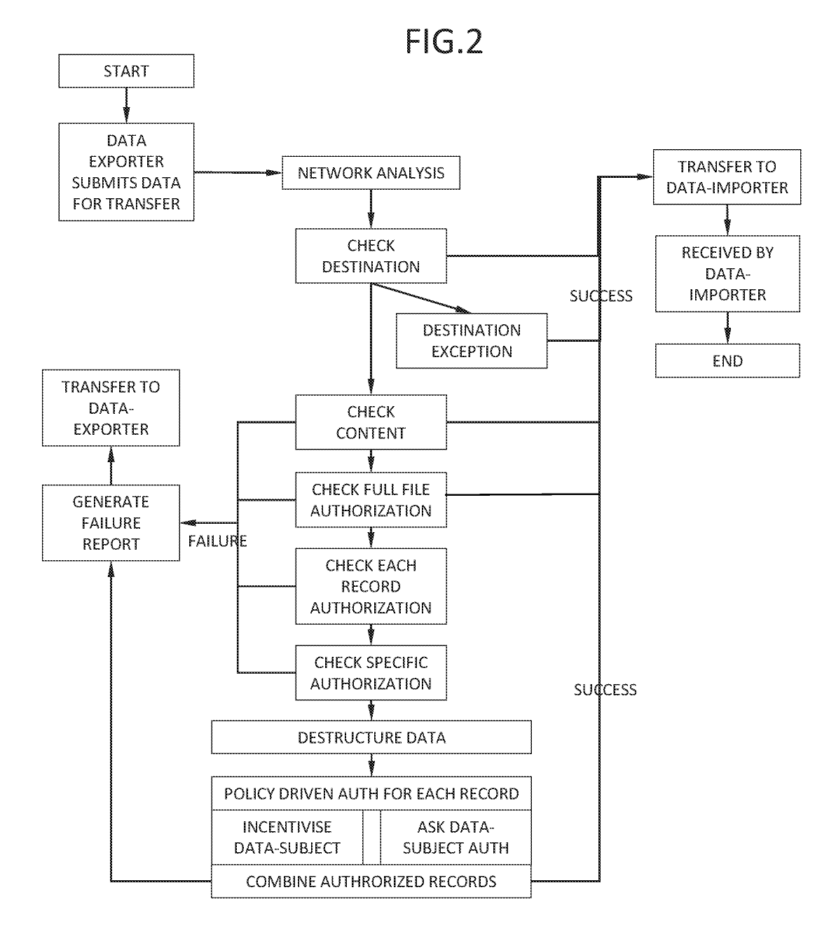

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provides a system method and apparatus to control the exchange of protected privacy information (PI) across jurisdictional boundaries. By using a combination of a network based communication and a network artificial intelligence (AI) platform through the XcooBee global network, the XcooBee network will automatically identify PI transfers across legal boundaries requiring specific permissions and/or auditable compliance steps.

Once transfers containing information subject to regulation have been identified, the XcooBee network can engage with each known data-subject when necessary. The solution extends to cases where data-exporters have obtained permission in advance as well as occurrences when specific permission or incentive payments can be offered for the data-use to the data-subjects. With the assistance of the XcooBee network, all these use cases can be handled on a one-on-one basis.

In other aspects, the system can compile a compliant data-set by extracting individual records and transparently validating them. It will construct a new, validated data-set, with PI compliant export-data. Moreover, compliance officers can be involved with transfers and the system can monitor such transfers globally to ensure that even unintended transfers are accounted for by the system. The system guarantees compliance while saving costs and makes the impractical, readily achievable.

A system according to aspects of the invention may include computer network 1 that connects one or more data-exporters, data-importers and data-subjects and is accessible via the general Internet like the XcooBee network. A globally distributed secure network storage 2 may be utilized to store PI data for one or more data subjects. A network software 3 is configured to exchange information between a plurality of computing devices 4, such as a laptop, desktop, mobile device or tablet. An application, or app 5, includes software instructions that are downloadable to a user's computing device 4, and may be configured as a browser, or as app, or as user interface.

An application, or app 5 is installed on a current computer device 4. The app 5 translates user interactions, taps, clicks, swipes and entries, into commands to be processed by the network software 3. The network software 3 will cause data that is transferred from the computing device 4 to be stored in a distributed storage 2 and analyzed to determine an association with data-subjects. The computer network 1 is determine through software logic how and when it will need to involve data-subjects in the transfer of data from the distributed storage 2 to a data-importer. This will occur according to instructions and business logic resident in network software 3.

The data-exporter can, utilize a computing device 5, to initiate a data-share to data-an importer. The network software 1 stores and forwards information using network storage 2. During transfer from or between the data-exporter to the data-importer, the network software 3 will run an analysis as to whether legal boundaries are being crossed as the data transits the network. If the software determines that a legal boundary is being crosses, further analysis will take place as to each individual record associable with data-subjects.

The network software 1 may be configured to review polices of the data-exporter and the data-subject pertaining to the matter and logically work through the process. The network software 1 reviews existing system policies and agreements between data-exporter and each individual data-subject. If the network software 1 determines that no provisions exist, it will contact the data-subjects to obtain permissions, where needed. The network software 1 may also offer incentives to the data-subject to allow the export to be approved.

Using a collection of settings, the network software 1 will determine how long it will wait on responses, what incentive it will offer, and, when needed, and how it will assemble an exportable package. It will, then, re-assemble an export certified data package in network secure storage 2 and inform the data-exporter and importer about changes. And, finally deliver the cleared package to data-importer.

A process according to aspects of the invention starts with the desire to transfer data containing PI. By using the XcooBee network, the network can automatically determine whether this data falls under one or more data-export and protection rules that would apply when such data transits within or is moved across legal data share jurisdictional boundaries.

By way of non-limiting example, a process according to aspects of the present invention may be executed according to the following:
1. Initiated by data-exporter sending a file with data that clearly identifies data-subject.
2. The XcooBee Network (The Network) detects that this file crosses or transits a legal boundary and performs a network analysis.
   a. The Network reviews policy governing files crossing legal boundaries.
   b. The following rules are reviewed first on a file level (overall exception), if no file level exception can be found, each individual record contained in the file is reviewed
      i. Exceptions can be registered based on combination of data-type, destination.
         1. The data-exporter can register a transfer-justification with the network
         2. The transfer justification can be added dynamically during data-exporter approval
3. The Network continues the analysis in more detailed level once legal border crossing has been determined
   a. The policies for whole files are reviewed
      i. If transfer exception exists, the file is transferred to data-importer
      ii. If no whole policy matches, the default policy is consulted
         1. The Network may move to detail level file analysis
         2. The Network may present the transaction to authorized approver to enter a transfer-justification and approve
         a. If there is no transfer-justification provided the data export is cancelled and logged
         b. If transfer justification is provided, file is transferred
   b. The policies for record level privacy exports are reviewed
      i. A file deconstruction process is started that will separate each record and build a new file with only authorized records.
      ii. Each record in file is examined and associated user identified
         1. Data-exporter contract arrangements are associated. If the data-exporter can claim existing permission, the record is moved to authorized file.
         2. If there is no contract arrangement the data-subject may be asked to provide authorization for transfer. If the data subject approves, the record is moved to authorized file. The data-subject may be provided an incentive payment to authorize the transfer.
         a. The amount of incentive may differ by each record, the length and scope of authorization. The Network will use an algorithm to determine optimal incentive if so instructed by data exporter.
         b. The Network may inject tracking data on behalf of the data-subject if so instructed to associate this exchange specifically so that the misuse of the data can be more easily detected.
         3. The data-subject policy records are reviewed. If the data-subject allows the data-exported to move files between affiliates, or has allowed the export of data, the record is moved to authorized file.
      iii. Records that are not authorized after a set time, will be recorded as unauthorized.
         1. An error report will be generated identifying an unauthorized transfer to data-exporter.
      iv. The participation of in this program is optional. however, when any one party is participating the other parties are automatically introduced.

As thus configured, the system has a collection of logic gates to handle any combination of participation between the data-subject, the data-importer, and the data-exporter.

In use, the data-exporter initiates the process by sending a file containing data with information that clearly identifies users across legal boundaries. To do so, the data-exporter logs in to their XcooBee account and initiates a transfer via the UI or API (application programming interface). The Network software analyzes the path of the transfer (source, destination and content) and engages in steps to mitigate data-exporter and importer risks by ensuring that only authorized transfer take place.

The Network validates destination, content, and authorization globally (for the whole file) and/or for each record. Data-exporter and data-subject policies are consulted to ensure that the transfer is authorized. If additional authorizations are needed, the Network will involve data-exporter and data-subjects to collect the authorization. The data-exporter can specifically approve and provide transfer-justification in the application, while the data-subject can authorize broad or narrow use of their data by the data-exporter in the application.

The Network, then, either assembles a fully authorized file and transfers to data-importer or the whole authorized file. The data-importer can use the system UI or API to download the fully authorized file for its use.

The invention standardizes the transfer across border process but it can be used by data-subjects to monitor the use of their privacy related data. Thus, this could be used as a baseline for safety monitoring services similar to credit monitoring. The ability of the XcooBee network to add specific tracking data into the exchange allows the network to track potential misuse. Reporting can be generated with geographic usage patterns as well as share patterns for data-subject and data-exporters. The system can also invite unknown users to join the network platform for active management or interact with XcooBee network via email or phone (messaging).

The system of the present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The computer-based data processing system and method described above is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A computerized method for controlling the exchange of a file, containing one or more elements of privacy information (PI), between a data exporter and a data importer, comprising:
initiating a transfer of a file within a computer network between the data-exporter and the data importer, the file containing PI data of a data-subject,
determining whether the transfer will transit a PI jurisdictional boundary between the data exporter and the data importer;
when the PI jurisdictional boundary does not exist, transferring the file to the data importer.

2. The computerized method of claim 1, further comprising:
when the PI jurisdictional boundary exists, analyzing one or more governing PI data policies between a first jurisdiction of the data exporter and a second jurisdiction of the data importer;
when the one or more governing PI data policies indicates a destination exception for the second jurisdiction, transferring the file to the data importer.

3. The computerized method of claim 1, further comprising:
when the PI jurisdictional boundary exists, analyzing one or more governing PI data policies between a first jurisdiction of the data exporter and a second jurisdiction of the data importer;
determining whether the one or more PI data policies specifies a file level exception for the PI data;
when a file level exception exists, transferring the file to the data importer; and
when a file level exception does not exist, generating a failure report.

4. The computerized method of claim 1, further comprising:
registering a transfer justification with the network by the data-exporter, the transfer justification specifying a combination of a data type and a destination.

5. The computerized method of claim 4, further comprising:
determining whether the file satisfies the transfer justification; and
when the file satisfies the transfer justification; transferring the file to the data importer.

6. The computerized method of claim 5, further comprising:
when the file does not satisfy the transfer justification, prompting an authorizing party of the data exporter for a specific authorization to transmit the file across the jurisdictional boundary;
when the authorizing party approves the specific authorization, authorizing the transfer of the file across the jurisdictional boundary, transmitting the file to the data importer; and
when the specific authorization is not received, generating a failure report.

7. The computerized method of claim 5, further comprising:
when the transfer justification is not satisfied, determining for each of a plurality of records contained in the file, whether a record authorization exists for each of the plurality of records;
when the record authorization exists for each of the plurality of records in the file, transferring the file to the data importer; and
when the record authorization does not exist for each of the plurality of records in the file, generating a failure report.

8. The computerized method of claim 2, further comprising:
when the PI jurisdictional boundary exists, analyzing one or more governing PI data policies between a first jurisdiction of the data exporter and a second jurisdiction of the data importer;
deconstructing the file to perform a record level privacy export assessment for each a plurality of records contained in file against the one or more governing PI data policies;
adding an authorized record, satisfying the one or more governing PI data policies to an authorized record file.

9. The computerized method of claim 10, further comprising:
determining whether the data subject of an individual record is associated with the computer network; and
determining whether the associated data subject has provided a prior PI data transmission authorization with the network;
when the associated data subject has provided a prior authorization for transferring PI data of the data subject, adding an associated record of the associated data subject to the authorized file.

10. The computerized method of claim 9, further comprising:
when the associated data subject has not provided a prior authorization, soliciting an authorization from the associated data subject.

11. The computerized method of claim 10, further comprising:
when the associated data subject approves the authorization, adding the associated record to the authorized record file.

12. The computerized method of claim 9, further comprising:
offering an incentive to the associated data subject.

13. The computerized method of claim 1, further comprising:
inserting tracking data into the file, the tracking data enabling the data subject to determine a misuse of the PI data.
